(19) United States
(12) Patent Application Publication
(10) Pub. No.: US 2015/0117259 A1
(43) Pub. Date: Apr. 30, 2015

(54) SYSTEM AND METHOD FOR ARTIFICIAL INTELLIGENCE CLOUD MANAGEMENT

(71) Applicant: REMTCS, Inc., Red Bank, NJ (US)

(72) Inventors: Tommy Xaypanya, Lamar, MS (US); Richard E. Malinowski, Colts Neck, NJ (US)

(21) Appl. No.: 14/528,560

(22) Filed: Oct. 30, 2014

Related U.S. Application Data
(63) Continuation of application No. 14/163,186, filed on Jan. 24, 2014.
(60) Provisional application No. 61/897,745, filed on Oct. 30, 2013.

(51) Int. Cl. H04L 12/24

(52) U.S. Cl. CPC H04L 41/0896
USPC 370/254

(57) ABSTRACT

An artificial intelligence engine is provided to analyze a network's bandwidth. The artificial intelligence engine then causes devices, such as links and traffic processing units to be dynamically allocated or de-allocated. The network may comprise a layered network or stacked cloud network whereby an overlaying network comprises a neural cluster of one or more of the artificial intelligence engines. The underlying network comprises the links connecting one or more devices, such as processing components and endpoints.

### CROSS-REFERENCE TO RELATED APPLICATIONS

The present application is a continuation application of U.S. patent application Ser. No. 14/163,186, filed on Jan. 24, 2014, and claims the benefit of U.S. Provisional Patent Application No. 61/897,745, filed on Oct. 30, 2013, both of which are incorporated herein by reference in their entirety.

### FIELD OF THE DISCLOSURE

The present disclosure is generally directed toward the allocation and management of computational resources.

### BACKGROUND

Networking changed the information technology industry by enabling different computing systems to communicate, collaborate and interact by enabling an artificial intelligence to control and adapt the network to patterns found within the data. There are many types of networks. The Internet is one of the more ubiquitous and largest networks on Earth. The Internet connects millions of computers all over the world. Wide Area Networks (WAN) are networks that are typically used to connect the computer systems of a corporation, educational institution, or other entity located in different geographies. Local Area Networks (LAN) are networks that typically provide connectivity in a home or office environment.

The purpose of a network is to enable communications between the systems that are connected to the network by delivering information from the source of the information to its destination. In such a mission, the network itself needs to have sufficient processing capacity and bandwidth capacity in order to perform data delivery and processing tasks, including determining an appropriate route for the traffic to travel, handling errors and accidents, and ensuring the necessary security measures are in place.

A typical network includes two types of components: traffic processing components and connectivity components. Traffic processing components include the various types of networking devices such as routers, switches, hubs, etc. that routes data to its intended destination. The connectivity components typically referred to as “links” interconnect two processing components or end points. Network links may comprise physical network links, such as Ethernet cable, wireless connectivity components, satellite connectivity components, fiber optics, dial-up phone line, ISDN, DSL, and so on. Virtual network links refer to logic links formed between two entities (processors and/or endpoints) and may incorporate one to many physical links, as well as various processing components. The combined processing capacity of the traffic processing components utilized by a network determines that network's processing capacity. The bandwidth capacity of the links, and the configuration thereof, determines the bandwidth capacity for a given network.

When designing and managing a network, it is often of crucial importance to provision sufficient capacity. When there is not enough capacity for a network, problems arise, such as degraded performance due to congestion to packet loss and component malfunctions.

In the prior art, network design and management are based on a fixed capacity that is provisioned beforehand. Typically, one would acquire all the hardware and software components, configure them, and then build the connectivity between them. This fixed infrastructure provides a fixed capacity.

A common problem with fixed capacity solutions is the high acquisition cost and over-provisioning or under-provisioning of capacity. Acquiring all the traffic processing components and setting up the links upfront can be very expensive for a large-scale network. The cost to build a large-scale network can range from millions of dollars on up. For example, the Internet costs billions of dollars to build and ongoing investment in the millions is provided to improve capacity.

An important aspect of most networks is the fact that network traffic demand varies. Peak demands can be a few hundred percent or even higher than the average demand. In order to meet the needs of peak demand, the capacity of the network has to be over-provisioned for non-peak usage. For example, a rule of thumb for network design states that peak demand should be 3-5 times that of normal demand. Such over-provisioning is necessary in order for the network to function properly during peak usage and meet service agreement obligations. However, normal bandwidth demand and processing demand are significantly lower than peak demands. It is not unusual to see a typical network's utilization rate to be only at 20%. Thus a significant portion of capacity is wasted. For large-scale networks such waste is significant and ranges from thousands to millions of dollars. Furthermore, such over-provisioning creates a significant carbon footprint. Today's telecommunication networks are responsible for 1% to 5% of global carbon footprint, and this percentage has been rising rapidly due to the rapid growth and adoption of information technology. Because prior art networks are based on fixed capacity, service suffers when capacity demand overwhelms the fixed capacity and waste occurs when demand is below the provisioned capacity.

### SUMMARY

It is with respect to the above issues and other problems that the embodiments presented herein were contemplated. There is an unfulfilled need for new approaches to build and manage a network that can eliminate the expensive upfront costs, reduce capacity waste, and improve utilization efficiency, such as by integrating an artificial intelligence to manage the network and the operation thereof.

Aspects of certain embodiments of the present disclosure relate to network design and management and in particular to systems and methods for an adaptive network management using artificial intelligence with automatic capacity scaling in response to and/or anticipation of load demand changes.

In one embodiment, a system is disclosed for managing bandwidth capacity of a network comprising: a network interface operable to access a bandwidth capacity of the network and a bandwidth utilization of the network, wherein the network comprises an allocated number of traffic handling components, each traffic handling component providing a portion of the bandwidth of the network; an artificial intelligence engine, operable to determine a target bandwidth capacity and further operable to signal a traffic handling unit manager in accord with the target bandwidth; and the traffic handling unit manager operable to, upon receiving the signal from the artificial intelligence engine, allocate an adjusted number of traffic handling components selected to reduce the difference between the bandwidth capacity and the target bandwidth capacity.

In another embodiment, an artificial intelligence engine is disclosed, comprising: an input to receive a bandwidth capacity of a network and a bandwidth utilization of the network, wherein the network comprises an allocated number of traffic handling components, each traffic handling component providing a portion of the bandwidth of the network; a logic unit operable to determine a target bandwidth capacity; and an output operable to signal a traffic handling unit manager in accord with the target bandwidth.

In yet another embodiment, a method is disclosed for managing bandwidth capacity of a network comprising: accessing a bandwidth capacity of the network and a bandwidth utilization of the network, wherein the network comprises an allocated number of traffic handling components, each traffic handling component providing a portion of the bandwidth of the network; determining, by an artificial intelligence engine, a target bandwidth capacity and further operable to signal a traffic handling unit manager in accord with the target bandwidth; and receiving, by the traffic handling unit manager, the signal from the artificial intelligence engine, and allocating an adjusted number of traffic handling components selected to reduce the difference between the bandwidth capacity and the target bandwidth capacity.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a network in accordance with embodiments of the present disclosure;

FIG. 2 depicts a stacked cloud network in accordance with embodiments of the present disclosure; and

FIG. 3 depicts a method in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedence.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

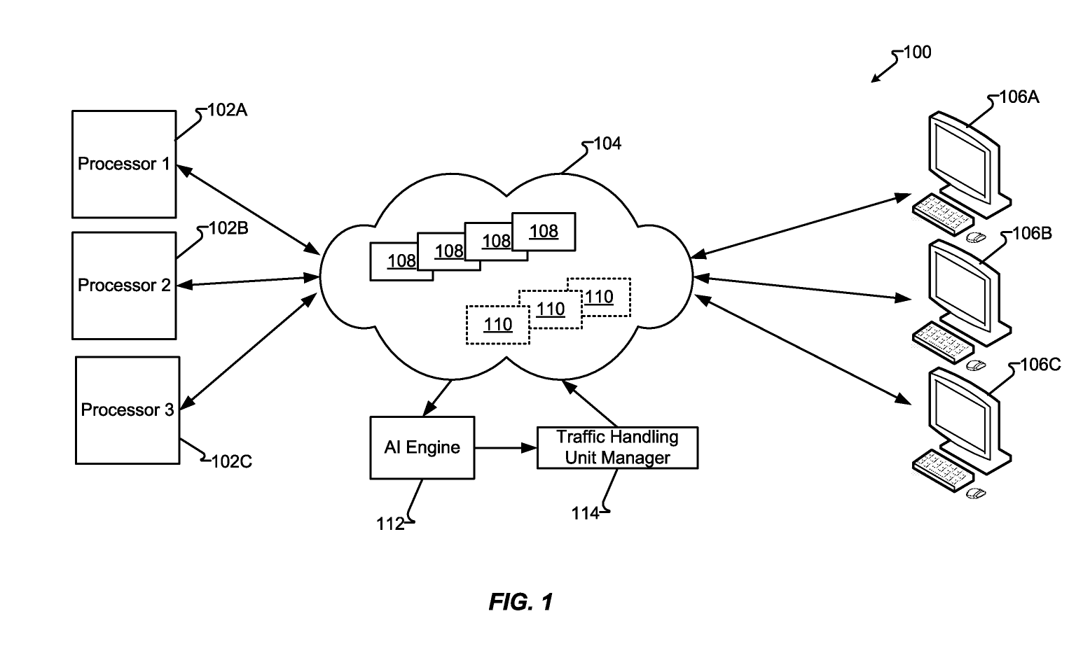

FIG. 1 depicts network 100 in accordance with embodiments of the present disclosure. In one embodiment, network 100 comprises a number of processors 102 and a number of endpoints 106. Communication, between processors 102 and/or endpoints 106 is facilitated via managed network 104. One or more of processors 102 may be discrete processing unit and/or a processing device, such as a server, array of servers, server farm, etc.

In another embodiment, managed network 104 comprises a number of allocated traffic handling devices, such as allocated traffic handling devices 108 and/or non-allocated traffic handling devices 110, each being one of traffic handling devices 108, 110. Allocated traffic handling devices 108 is operational and carrying, or at least operable to carry, traffic on managed network 104. Non-allocated traffic handling device 110 is, for at least one reason, unable to carry traffic of managed network 104 and generally comprises non-allocated traffic handling device 110 being physical and/or logically disconnected from managed network 104.

Traffic handling devices 108, 110 may comprise traffic processing units (e.g., hubs, routers, switches, etc.) and/or links which may be physical, logical, or a combination thereof. Physical links include cables, telephone lines, wireless connection components, etc. Logical links provide logical connectivity via physical links. Traffic processing devices 108, 110 may utilize virtual machines and physical machines. The virtual machines may incorporate virtualization technology including REMTCS Secure Hypervisor.

In another embodiment, artificial intelligence engine 112 receives bandwidth utilization from managed network 104. Artificial intelligence engine 112 may also receive current bandwidth capacity. Such bandwidth utilization and/or bandwidth capacity may be updated periodically, from many days or months down to sub-microseconds, in accord with the network. For example, managed network 104 may experience peaks during certain times of the year and updating utilization and/or capacity information provided for on a monthly or weekly basis. A shorter duration between the updates may still be provided as a matter of implementation choice, such as to avoid unexpected peaks that fall outside of the normal seasonal peaks. Bandwidth capacity may be updated periodically or on demand, such as upon traffic handling unit manager 114 performing an allocation and/or de-allocation of a traffic handling device 108, 110.

In one embodiment, artificial intelligence engine 112 determines a target bandwidth for the managed network 104 and signals traffic handling unit manager 114 to de-allocate traffic handling devices 108 and/or allocate non-allocated traffic handling device 110 accordingly. Simultaneous, or nearly simultaneous, allocation/de-allocation of allocated traffic handling device 108/non-allocated traffic handling device 110 may be performed when the capacity and/or type of device is dissimilar. For example, artificial intelligence engine 112 may determine that managed network requires an increase in capacity that can only be provided by allocating a high-capacity non-allocated traffic handling device 110, but to avoid over provisioning the network, de-allocating allocated traffic handling device 108, which has a lower capacity. To put it more simply, adding nine may be achieved by adding ten and subtracting one, preferably at substantially the same time or in that order so as to not exacerbate the bandwidth under capacity of managed network 104.

In another embodiment, traffic handling unit manager 114 may ignore, entirely or until the occurrence of another event, the signal from artificial intelligence engine 112, such as when the granularity of change is greater than the change in bandwidth that would result from the allocation/de-allocation of one traffic handling device 108, 110. For example, if each traffic handling device 108, 110 contributes ten gigabits a second to the capacity of managed network 104, and artificial intelligence engine 112 indicates an over capacity of the network of three gigabits, traffic handling unit manager 114 may not de-allocate any allocated traffic handling device 108 as doing so would result in an under capacity of bandwidth by seven gigabits.

While a certain amount of over capacity may be acceptable, there may be very limited tolerance for under capacity. Therefore, in another embodiment, any under capacity determined by artificial intelligence engine 112 causes traffic handling unit manager to allocate a non-allocated traffic handling device 110 to become one of allocated traffic handling device 108. In a further embodiment, an acceptable delay and/or acceptable amount of under allocation of capacity may be permitted before allocation of an additional non-allocated traffic handling device 110. For example if allocation of non-allocated traffic handling device 110 takes twenty seconds but the demand is expected to subside within that time, or a previously determined acceptable time beyond, then the allocation of non-allocated traffic handling device 110 may be omitted.

In another embodiment, artificial intelligence engine 112 determines a target bandwidth and the number, or even identity, of specific traffic handling devices 108, 110 to allocate or de-allocate. Then, artificial intelligence engine 112 signals traffic handling unit manager which execute the allocation or de-allocation. In yet another embodiment, artificial intelligence engine 112 is integrated with traffic handling unit manager 114.

Managed network 104 may have a number of allocated traffic handling devices 108 and/or one or more non-allocated traffic handling devices 110. Non-allocated traffic handling devices 110 may be allocated for another task or put into a standby mode or then, or alternatively, shut down. Traffic handling unit manager 114 may allocate de-allocated traffic handling device 110 and thereby place non-allocated traffic handling device 110 to become allocated and become one of allocated traffic handling devices 108.

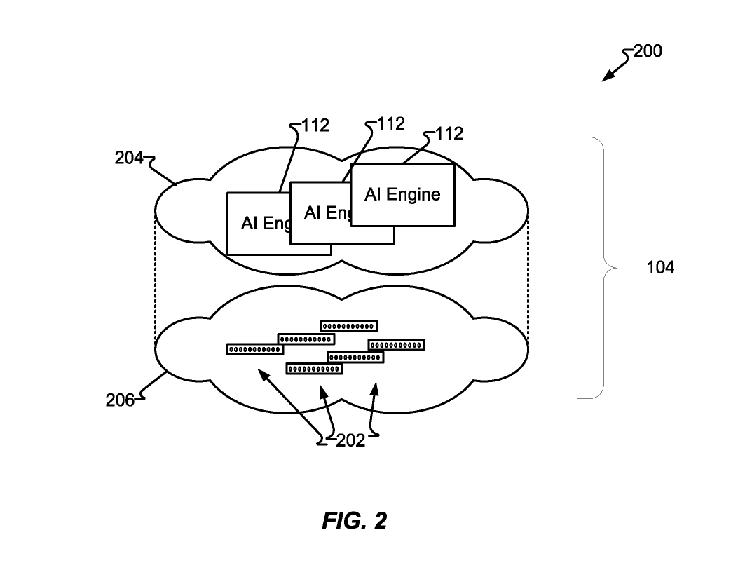

FIG. 2 depicts stacked cloud network 200 in accordance with embodiments of the present disclosure. Managed network 104 may comprise two or more stacked cloud networks, such as overlay network 204 and underlay network 206. In another embodiment, overlay network 204 comprises one or more artificial intelligence engines 112, which may further form a neural network of said artificial intelligence engines 112. In another embodiment, underlay network 206 comprises one or more links (e.g., hubs, routers, switches, etc.).

In another embodiment, managed network 104 may comprise two or more stacked clouds. One cloud may form overlay network 204 and another cloud may form underlay network 206. Other clouds may be incorporated as separate clouds or components thereof, for example, REMTCS Anni Cloud Stack.

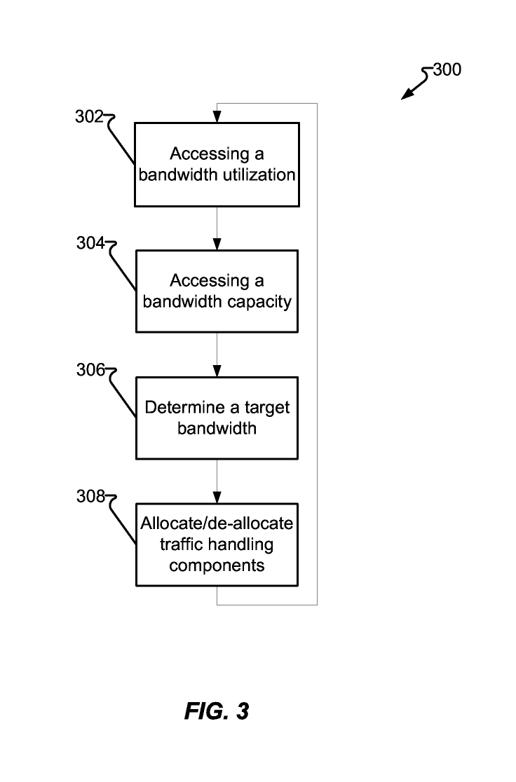

FIG. 3 depicts method 300 in accordance with embodiments of the present disclosure. In one embodiment method 300 starts with step 302 accessing a bandwidth utilization. For example, artificial intelligence engine 112 receives, via push or pull notification, the bandwidth utilization of managed network 104. Artificial intelligence engine 112 may access a single “dashboard” value and/or poll all or sample a portion of the number of allocated traffic handling devices 108. Processing continues to step 304.

Step 304 accesses a bandwidth capacity of the network. For example artificially intelligence engine 112 may poll or sample allocated traffic handling devices 108 and/or receive push notifications therefrom. In another embodiment, artificial intelligence engine 112 accesses a stored value or values, such as when artificially intelligence engine 112 is the sole decision maker, or receives notification from the decision maker, as to the allocation of the number of allocated traffic handling devices 108. For example, if artificial intelligence engine 112 signals traffic handling unit manager 114 to allocate two additional allocated traffic handling devices 108, such as from non-allocated traffic handling devices 110, and no other capacity-influencing decisions are made, or if they are made artificial intelligence engine 112 is aware, then the capacity of managed network 104 is known by artificial intelligence engine 112. In another embodiment, a periodic inventory may be performed to verify the bandwidth capacity value known to artificial intelligence engine 112, such as to account for failed allocated traffic handling devices 108.

Next, in step 306, a target bandwidth is determined, such as by artificial intelligence engine 112. A margin may be incorporated into the target bandwidth determination to account or spikes in demand that may not be managed within the timeframe required. For example, if the allocation of allocated traffic handling device 108 takes thirty seconds to bring online, and the bandwidth utilization is determined to routinely vary by five percent over thirty second intervals, then having at least a five percent, and optionally more, to allow for usage spikes during the interval of non-responsiveness of allocated traffic handling device 108 being allocated. Other margins may be incorporated as an implementation preference.

In another embodiment, a target over capacity may be greater than zero but less than the capacity of a single allocated traffic handling device 108. In yet another embodiment, a target under capacity may be zero, or nearly so, when any under capacity is determined to be unacceptable. However, in other embodiments, some under capacity, especially if restricted to short or infrequent periods of time, may be acceptable.

Next, step 308 allocates or de-allocates one or more traffic handling units. For example, traffic handling unit manager may allocate non-allocated traffic handling device 110 to become one of allocated traffic handling devices 108 or de-allocate one or more of traffic handling devices 108 to become one of non-allocated traffic handling devices 110.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system for managing bandwidth capacity of a network comprising:
a network interface operable to access a bandwidth capacity of the network and a bandwidth utilization of the network, wherein the network comprises an allocated number of traffic handling components, each traffic handling component providing a portion of the bandwidth of the network;
an artificial intelligence engine, operable to determine a target bandwidth capacity and further operable to signal a traffic handling unit manager in accord with the target bandwidth; and
the traffic handling unit manager operable to, upon receiving the signal from the artificial intelligence engine, allocate an adjusted number of traffic handling components selected to reduce the difference between the bandwidth capacity and the target bandwidth capacity.

2. The system of claim 1, wherein the artificial intelligence engine is further operable to determine the target bandwidth capacity which is greater than the bandwidth capacity when the bandwidth utilization is determined to be substantially limited by the bandwidth capacity.

3. The system of claim 1, wherein the traffic handling components comprise links operable to communicatively connect at least two devices, wherein the devices comprise processing components and end-points.

4. The system of claim 1, wherein the traffic handling components comprise traffic processing units.

5. The system of claim 4, wherein at least one of the number of traffic handling units comprises a virtual machines provided by private and commercial cloud computing providers.

6. The system of claim 1, wherein the traffic handing unit manager is operable to allocate an adjusted number of traffic handling components selected to reduce the difference between the bandwidth capacity and the target bandwidth capacity within a previously determined margin.

7. The system of claim 1, wherein when the traffic handling unit manager is further operable to, upon the adjusted number of traffic handling units being negative, de-allocate a number of the traffic handling units.

8. The system of claim 7, wherein the traffic handling unit manager is operable to de-allocate at least one traffic handling units by allocating the at least one traffic handling units to a task other than processing bandwidth for the network.

9. The system of claim 1, wherein said network comprises an overlay network superimposed over an underlying network and wherein the overlay network comprises a neural cluster comprising at least one artificial intelligence engine.

10. The system of claim 1, wherein the underlying network comprises traffic handling units comprise links operable to communicatively connect at least two devices, wherein the devices comprise processing components and end-points.

11. An artificial intelligence engine, comprising:
an input to receive a bandwidth capacity of a network and a bandwidth utilization of the network, wherein the network comprises an allocated number of traffic handling components, each traffic handling component providing a portion of the bandwidth of the network;
a logic unit operable to determine a target bandwidth capacity; and
an output operable to signal a traffic handling unit manager in accord with the target bandwidth.

12. The artificial intelligence engine of claim 11, wherein the input is further operable to receive the bandwidth capacity and bandwidth utilization periodically.

13. The artificial intelligence engine of claim 11, wherein the logic unit is operable to determine a target bandwidth capacity as an estimated future target bandwidth capacity.

14. A method for managing bandwidth capacity of a network comprising:
accessing a bandwidth capacity of the network and a bandwidth utilization of the network, wherein the network comprises an allocated number of traffic handling components, each traffic handling component providing a portion of the bandwidth of the network;
determining, by an artificial intelligence engine, a target bandwidth capacity and further operable to signal a traffic handling unit manager in accord with the target bandwidth; and
receiving, by the traffic handling unit manager, the signal from the artificial intelligence engine, and allocating an adjusted number of traffic handling components selected to reduce the difference between the bandwidth capacity and the target bandwidth capacity.

15. The method of claim 14, wherein the step of determining the target bandwidth capacity further comprises determining the target bandwidth capacity upon the bandwidth utilization being determined to be substantially limited by the bandwidth capacity.

16. The method of claim 14, wherein the traffic handling components comprise links operable to communicatively connect at least two devices, wherein the devices comprise processing components and end-points.

17. The method of claim 14, wherein the traffic handling components comprise traffic processing units.

18. The method of claim 17, wherein at least one of the number of traffic handling units comprises a virtual machines provided by private and commercial cloud computing providers.

19. The method of claim 14, wherein said network comprises an overlay network superimposed over an underlying network and wherein the overlay network comprises a neural cluster comprising at least one artificial intelligence engine.

20. The method of claim 14, wherein the underlying network comprises traffic handling units comprise links operable to communicatively connect at least two devices, wherein the devices comprise processing components and end-points.
